(19) United States
(12) Patent Application Publication
(10) Pub. No.: US 2014/0138225 A1
(43) Pub. Date: May 22, 2014

(54) KEY SWITCH STRUCTURE

(71) Applicant: OKI ELECTRIC INDUSTRY CO., LTD., Tokyo (JP)

(72) Inventor: Shigeru Yamada, Gunma (JP)

(73) Assignee: Oki Electric Industry Co., Ltd., Tokyo (JP)

(21) Appl. No.: 14/131,602

(22) PCT Filed: Oct. 25, 2012
(86) PCT No.: PCT/JP2012/077638

§ 371 Date: Jan. 8, 2014

(30) Foreign Application Priority Data
Dec. 27, 2011 (JP) 2011-286648

(51) Int. Cl. H01H 13/14

(52) U.S. Cl. CPC H01H 13/14
USPC 200/345

(57) ABSTRACT

A link mechanism detachably supporting a key top against a back sheet provides a first link member; one end side of the first link member is rotatably held at the obverse surface of the back plate, and the other end side is slidably held at the reverse surface of the key top. A second link member is rotatably connected to the first link member. One end side of the second link member engages rotatably with a rotation support part provided to the reverse surface of the key top and the other end side of the second link member is slidably held at the obverse surface of the back plate. A recess is provided to the second link member, and a protrusion is formed on the rotation support part. The protrusion engages with the recess and restricts detachment of the key top from the second link member.

### TECHNICAL FIELD

The present invention relates to a key switch structure, and particularly relates to a key switch structure to be used at a keyboard of information processing equipment, measurement equipment, clinical equipment, a personal computer, a word processor or the like.

### BACKGROUND ART

In a keyboard, it is required that “operability” be assured, meaning that a key top should descend without tilting, regardless of which part of the key top is pressed. As a key switch structure that meets this requirement, a key switch structure has been developed (for example, see Japanese Patent No. 4,341,733) that includes a key top and a link mechanism, the link mechanism being provided below the key top and guiding the key top in an up-and-down direction.

In this key switch structure, the link mechanism is structured by an outer side link member that is formed in a frame shape and an inner side link member that is formed in a similar frame shape being combined into an X shape. This link mechanism is disposed between the key top and a back plate.

### DISCLOSURE OF INVENTION

### Technical Problem

However, when a keyboard in which the key switch structures are structured as described above is reduced in thickness, if a fingernail or the like catches under a key top during use of the keyboard, particularly when a key is being pressed, it is easy for the key top to detach from the link mechanism.

The present invention has been made to solve the problem described above, and an object of the present invention is to provide a key switch structure in which it is hard for a key top to detach from a link mechanism.

### Solution to Problem

An aspect of the present invention is provided with: a link mechanism that includes one link member, one end side of which turnably engages with a rotation support portion provided at a reverse surface of a key top that is depressed to allow a contact point to conduct electricity, and an other end side of which is slidably retained at a surface of a back plate, and an other link member that is turnably coupled with the one linked member, one end side of the other linked member being turnably retained at the surface of the back plate and an other end side of the other link member being slidably retained at the reverse surface of the key top, the link mechanism supporting the key top to be movable toward and away from the back plate; an engaging portion provided at the one link member; and an engaged portion formed at the rotation support portion, the engaged portion engaging with the engaging portion and restricting detachment of the key top from the one link member.

In this aspect, the engaging portion is provided at the one link member that is turnably engaged with the rotation support portion at the reverse surface of the key top and the engaged portion is provided at the rotation support portion. Because the engaging portion of the one link member engages with the engaged portion of the rotation support portion, even if the key top is lifted up relative to the link mechanism, the key top is unlikely to detach from the link mechanism.

In the aspect described above, the engaging portion is a recess formed at the one link member, the recess opening to a side thereof at which the back plate is disposed, and the engaged portion is a protrusion formed at the rotation support portion, the protrusion entering the recess through the opening thereof.

In this aspect, the engaging portion is formed at the one link member and is the recess that opens to the back plate side, while the engaged portion is formed at the rotation support portion and is the protrusion that fits into the recess.

Therefore, even when the key top is lifted up relative to the link mechanism, the protrusion catches on a wall at a side at which the recess does not open, and it is hard for the key top to detach from the one link member.

In the aspect described above, the engaging portion is a protrusion formed at the one link member, and the engaged portion is a recess formed at the rotation support portion, the recess being closed to a side thereof at which the back plate is disposed, and the protrusion entering the recess.

In this aspect, the engaging portion is the protrusion formed at the one link member, while the engaged portion is formed at the rotation support portion and is the recess of which the back plate side is closed and into which the protrusion fits. Therefore, even when the key top is lifted up relative to the link mechanism, the protrusion catches on a wall at the back plate side of the recess, and it is hard for the key top to detach from the one link member.

In the aspect described above, a turning pin is formed at the one end side of the one link member, the rotation support portion includes a pair of rotation support claws, rotation support surfaces being formed at faces at sides of the rotation support claws that oppose one another, the rotation support surfaces being concave surfaces that bear the turning pin, the recess is formed at the one link member in a vicinity of the turning pin, and the protrusion is formed at the rotation support claws.

In this aspect, when the turning pin of the one link member is inserted between the rotation support claws, the rotation support claws resiliently deform in directions to move apart from one another, and the turning pin is borne at the concave surfaces. In addition, the protrusion formed at the rotation support claws is fitted into the recess formed in the one link member. Therefore, the one link member may be attached to the rotation support portion simply by the turning pin being pressed between the rotation support claws until the turning pin is borne at the concave surfaces.

In the aspect described above, a turning pin is formed at the one end side of the one link member, the rotation support portion includes a pair of rotation support claws, rotation support surfaces being formed at faces at sides of the rotation support claws that oppose one another, the rotation support surfaces being concave surfaces that bear the turning pin, the protrusion is formed at the one link member in a vicinity of the turning pin, and the recess is formed at the rotation support claws.

In this aspect, when the turning pin of the one link member is inserted between the rotation support claws, the rotation support claws resiliently deform in directions to move apart from one another, and the turning pin is borne at the concave surfaces. In addition, the protrusion at the one link member is inserted into the recess in the rotation support claws. Therefore, the one link member may be attached to the rotation support portion at the reverse surface of the key top simply by the turning pin being pressed between the rotation support claws until the turning pin is borne at the concave surfaces.

In the aspect described above, a groove is formed in a face of each rotation support claw at the opposite side thereof from the side at which the concave surface is formed.

In this aspect, each rotation support claw is reduced in thickness by the groove being formed in the face of the rotation support claw at the opposite side thereof from the side at which the concave surface is formed. Therefore, even when the plate thickness of an upper face of the key top is reduced, occurrences of molding problems such as sink marks and the like at portions at which the rotation support claws are formed may be prevented.

### Advantageous Effects of Invention

As described hereabove, according to the present invention, a key switch structure in which it is hard for a key top to detach from a link mechanism is provided.

### BRIEF DESCRIPTION OF DRAWINGS

FIG. 1 is a sectional diagram showing the overall structure of a key switch structure in accordance with a first embodiment.

FIG. 2 is an exploded perspective diagram, viewed from diagonally above, showing the overall structure of the key switch structure in accordance with the first embodiment.

FIG. 3 is an exploded perspective diagram, viewed from diagonally above, showing a state in which a first link member and a second link member of the key switch structure in accordance with the first embodiment are combined to structure a link mechanism.

FIG. 4 is an exploded perspective diagram, viewed from diagonally below, showing the overall structure of the key switch structure in accordance with the first embodiment.

FIG. 5 is a plan view, viewed from below, in which the first link member and second link member of the key switch structure in accordance with the first embodiment are assembled to a reverse surface of a key top.

FIG. 6A is a plan view, viewed from below, showing structures of rotation support claws and surroundings thereof at the reverse surface of the key top provided in the key switch structure in accordance with the first embodiment.

FIG. 6B is a plan view, viewed from above, showing structures of turning pins and surroundings thereof at the second link member provided in the key switch structure.

FIG. 7 is a sectional diagram of the key switch structure in accordance with the first embodiment, which is a sectional diagram in which a section of the key top cut along plane A-A of FIG. 6A is viewed toward the rotation support claws and a sectional diagram in which a section of the second link member cut along plane B-B of FIG. 6B is viewed toward floor faces of cavity portions.

FIG. 8A is a magnified plan view showing an engagement relationship between a protrusion formed at the rotation support claws of the key top and a recess of the second link member in the key switch structure in accordance with the first embodiment.

FIG. 8B is a magnified side view showing the engagement relationship.

FIG. 9A is a plan view, viewed from below, showing structures of rotation support claws and surroundings thereof at the reverse surface of a key top provided in a key switch structure in accordance with a second embodiment.

FIG. 9B is a plan view, viewed from above, showing structures of turning pins and surroundings thereof at a second link member provided in the key switch structure.

FIG. 10 is a sectional diagram of the key switch structure in accordance with the second embodiment, which is a sectional diagram in which a section of the key top cut along plane A-A of FIG. 9A is viewed toward the rotation support claws and a sectional diagram in which a section of the second link member cut along plane B-B of FIG. 9B is viewed toward floor faces of cavity portions.

FIG. 11A is a plan view, viewed from below, showing structures of rotation support claws and surroundings thereof at the reverse surface of a key top provided in a key switch structure in accordance with a third embodiment.

FIG. 11B is a plan view, viewed from above, showing structures of turning pins and surroundings thereof at a second link member provided in the key switch structure.

FIG. 12 is a sectional diagram of the key switch structure in accordance with the third embodiment, which is a sectional diagram in which a section of the key top cut along plane A-A of FIG. 11A is viewed toward the rotation support claws and a sectional diagram in which a section of the second link member cut along plane B-B of FIG. 11B is viewed toward floor faces of cavity portions.

FIG. 13A is a plan view, viewed from below, showing structures of rotation support claws and surroundings thereof at the reverse surface of a key top provided in a key switch structure in accordance with a fourth embodiment.

FIG. 13B is a plan view, viewed from above, showing structures of turning pins and surroundings thereof at a second link member provided in the key switch structure.

FIG. 14 is a sectional diagram of the key switch structure in accordance with the fourth embodiment, which is a sectional diagram in which a section of the key top cut along plane A-A of FIG. 13A is viewed toward the rotation support claws and a sectional diagram in which a section of the second link member cut along plane B-B of FIG. 13B is viewed toward floor faces of cavity portions.

FIG. 15A is a plan view, viewed from below, showing structures of rotation support claws and surroundings thereof at the reverse surface of a key top provided in a key switch structure in accordance with a fifth embodiment.

FIG. 15B is a plan view, viewed from above, showing structures of turning pins and surroundings thereof at a second link member provided in the key switch structure.

FIG. 16 is a sectional diagram of the key switch structure in accordance with the fifth embodiment, which is a sectional diagram in which a section of the key top cut along plane A-A of FIG. 15A is viewed toward the rotation support claws and a sectional diagram in which a section of the second link member cut along plane B-B of FIG. 15B is viewed toward floor faces of cavity portions.

FIG. 17A is a plan view, viewed from below, showing structures of rotation support claws and surroundings thereof at the reverse surface of a key top provided in a key switch structure in accordance with a sixth embodiment.

FIG. 17B is a sectional diagram in which a section of the key top cut along plane C-C of FIG. 17A is viewed toward the rotation support claws.

FIG. 17C is a plan view, viewed from above, showing structures of turning pins and surroundings thereof at a second link member provided in the key switch structure.

FIG. 18 is a sectional diagram of the key switch structure in accordance with the sixth embodiment, which is a sectional diagram in which a section of the key top cut along plane A-A of FIG. 17A is viewed toward the rotation support claws and a sectional diagram in which a section of the second link member cut along plane B-B of FIG. 17B is viewed toward floor faces of cavity portions.

FIG. 19 is a sectional diagram showing the overall structure of a key switch structure in accordance with a seventh embodiment.

FIG. 20 is an exploded perspective diagram, viewed from diagonally above, showing the overall structure of the key switch structure in accordance with the seventh embodiment.

FIG. 21 is an exploded perspective diagram, viewed from diagonally above, showing a state in which a first link member and a second link member of the key switch structure in accordance with the seventh embodiment are combined to structure a link mechanism.

FIG. 22 is an exploded perspective diagram, viewed from diagonally below, showing the overall structure of the key switch structure in accordance with the seventh embodiment.

FIG. 23 is a plan view, viewed from below, in which the first link member and second link member of the key switch structure in accordance with the seventh embodiment are assembled to a reverse surface of a key top.

### BEST MODE FOR CARRYING OUT THE INVENTION

### 1. First Embodiment

Herebelow, a key switch structure 100, which is a first example of the key switch structure of the present invention, is described with reference to the drawings.

—Structure—

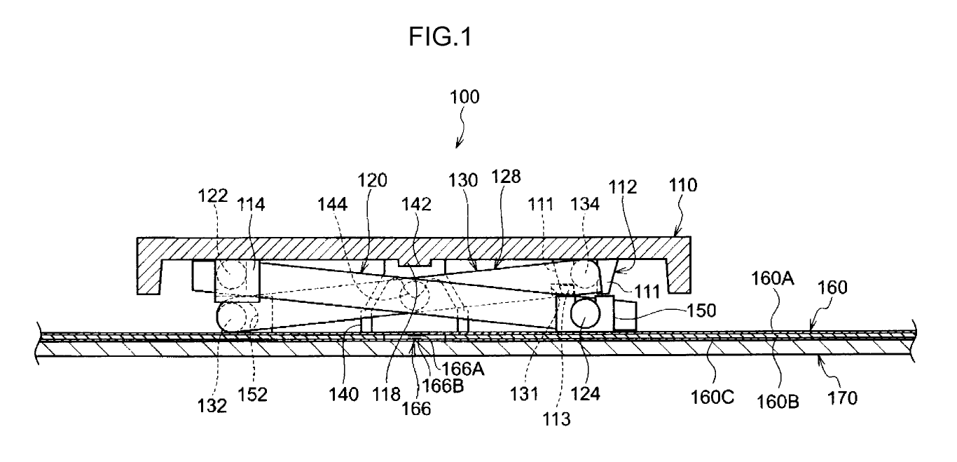

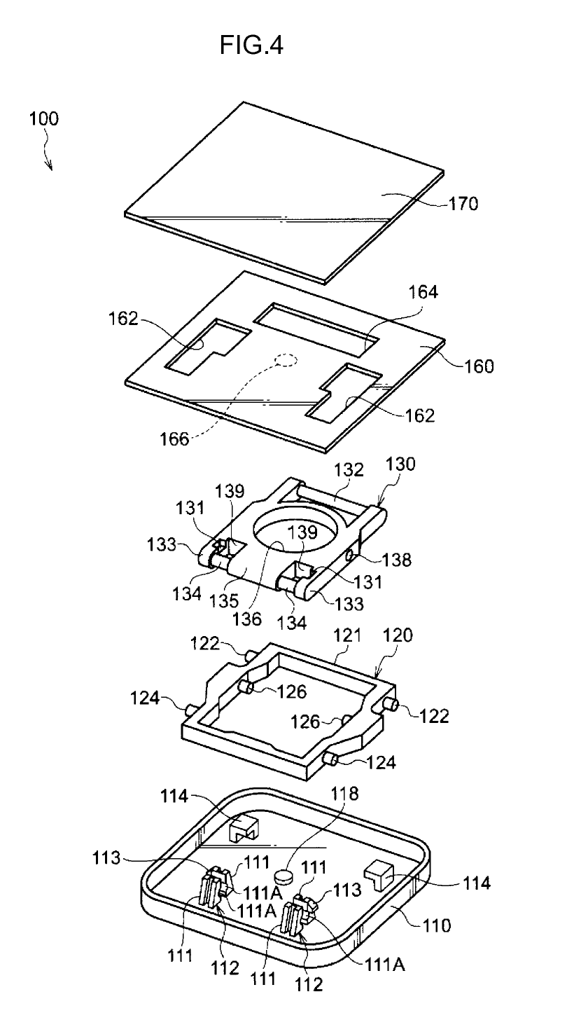

As shown in FIG. 1 to FIG. 4, the key switch structure 100 includes a key top 110, a link mechanism 128 including a first link member 120 and a second link member 130, a rubber dome 140 servings as an example of a resilient member, a membrane sheet 160 and a back plate 170 at which first holders 150 and second holders 152 are mounted. In this case, the first link member 120 serves as the other link member of the present invention and the second link member 130 serves as the one link member of the present invention.

The back plate 170 is a plate formed of a material provided with some degree of hardness and rigidity, such as a metal or a stiff resin or the like. The membrane sheet 160 has a structure in which an upper sheet 160A and a lower sheet 160C, on which wiring patterns are printed, sandwich a spacer sheet 160B. The membrane sheet 160 is formed of a soft material adhered to the surface of the back plate 170.

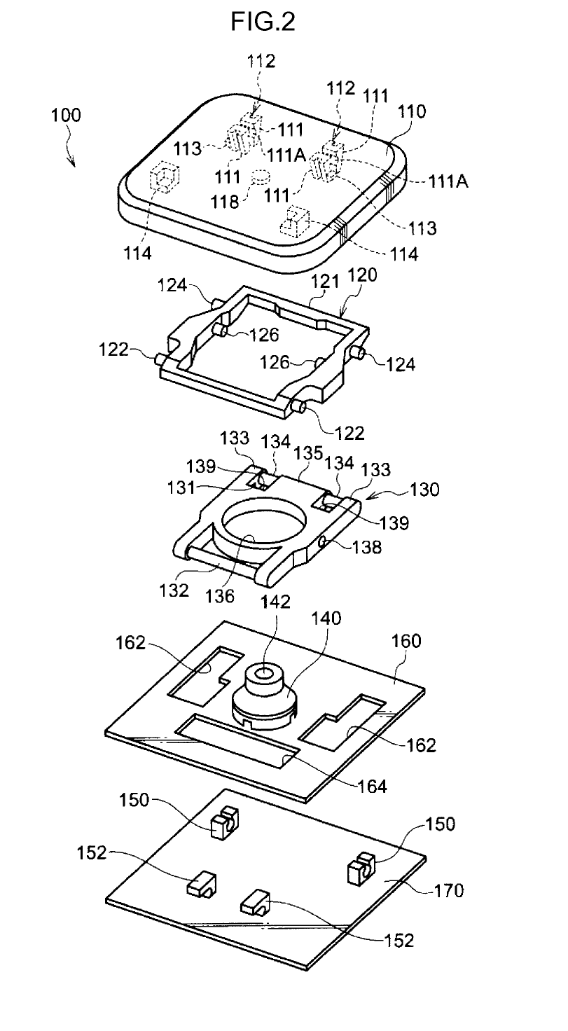

As shown in FIG. 2 to FIG. 4, holes 162 and 164 are formed in the membrane sheet 160 to match positions of the first holders 150 and second holders 152. Further, the membrane sheet 160 is adhered onto the back plate 170 in a state in which the first holders 150 and second holders 152 protrude through the holes 162 and 164, respectively.

As shown in FIG. 1, a contact portion 166 is provided at the middle of the membrane sheet 160. The contact portion 166 is constituted by an upper contact point 166A, which is provided at the upper sheet 160A, and a lower contact point 166B, which is provided at the lower sheet 160C. The rubber dome 140 is fixed by adhesive or the like between the membrane sheet 160 and the key top 110, over the contact portion 166. The rubber dome 140 is formed in a substantial cup shape of a material such as rubber or the like. The rubber dome 140 includes a fitting hole 142 at the middle of an upper portion thereof. A contact point-pressing portion 144 is formed, protruding toward the membrane sheet 160, at a central portion of an inner face of the rubber dome 140.

When the key top 110 is depressed, the key top 110 moves toward the membrane sheet 160 (the back plate 170) while being kept horizontal by operation of the link mechanism 128, which is described below. The rubber dome 140 is compressed and deforms, and the contact point-pressing portion 144 formed inside the rubber dome 140 presses on the region of the membrane sheet 160 at which the contact portion 166 is provided.

When the contact portion 166 region of the membrane sheet 160 is pressed, the upper contact point 166A and lower contact point 166B make contact and are electrically connected, acting as a switch in a closed state.

When the pressing of the key top 110 is released, the respective structural members are returned to their original states by restoring forces (resilience) of the rubber dome 140 and the membrane sheet 160. The contact at the contact portion 166 of the membrane sheet 160 is broken, and the electrical contact is ended. Thus, the switch goes into the open state.

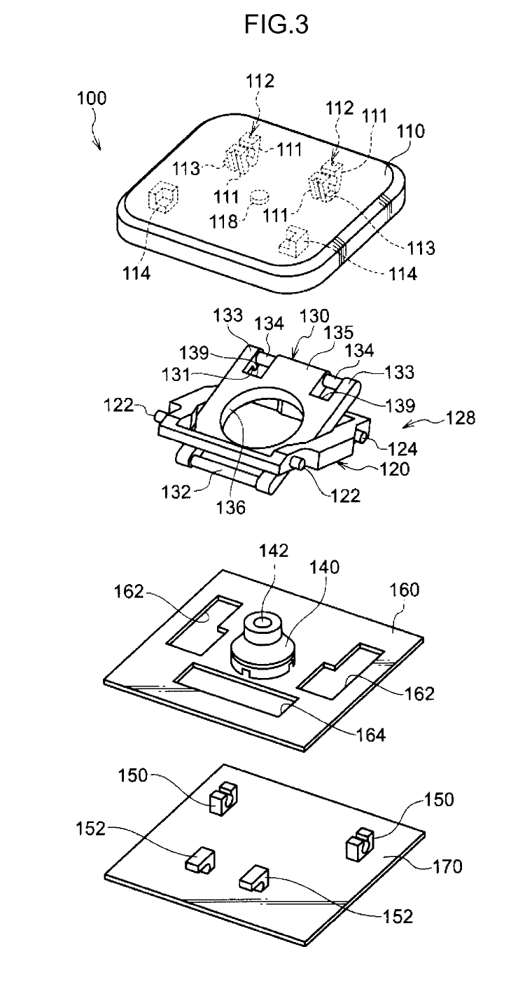

Herebelow, the first link member 120, the second link member 130 and the link mechanism 128 are described. As shown in FIG. 3, the first link member 120 and the second link member 130 form a nested structure in which the second link member 130 is fitted in at the inner side of the first link member 120. Thus, the link mechanism 128 is structured as a pantograph mechanism by the first link member 120 and the second link member 130.

As shown in FIG. 2 to FIG. 5, the first link member 120 is the link member at the outer side of the link mechanism 128, and is provided with a frame body 121 formed in a substantially rectangular frame shape, a pair of turning pins 124, a pair of sliding pins 122 and a pair of turning axles 126. The pair of turning pins 124 are formed at one end side of the frame body 121, and are inserted into the first holders 150 of the back plate 170 and turnably retained thereat. The pair of sliding pins 122 are formed at the other end side of the frame body 121, and are retained at a surface at the reverse side of the key top 110 (the side that opposes the membrane sheet 160) to be slidable in a horizontal direction, that is, a direction along the surface of the membrane sheet 160. The pair of turning axles 126 protrude to the inner side from a central portion of the frame body 121.

As shown in FIG. 2 to FIG. 5, the second link member 130 is the link member at the inner side of the link mechanism 128, and a circular access hole 136, for allowing the rubber dome 140 to pass through, is opened at a central portion of the second link member 130. Thus, the second link member 130 is also formed in a frame shape overall.

An edge at one end side of the second link member 130 is formed with cavity portions 139 at two locations. The cavity portions 139 are cavitated in parallel with one another in a direction toward the access hole 136, that is, a direction toward the other end side of the second link member 130. A portion between the two cavity portions 139 serves as an inner rung portion 135, and respective portions at the outer sides of the cavity portions 139 serve as outer rung portions 133.

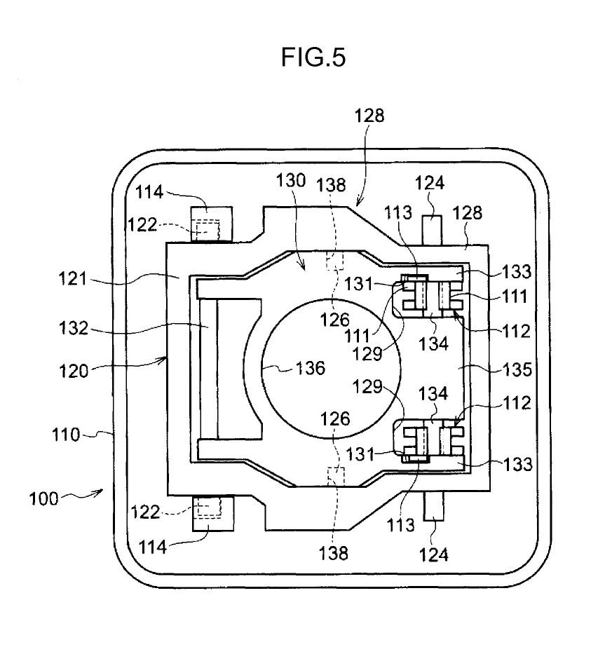

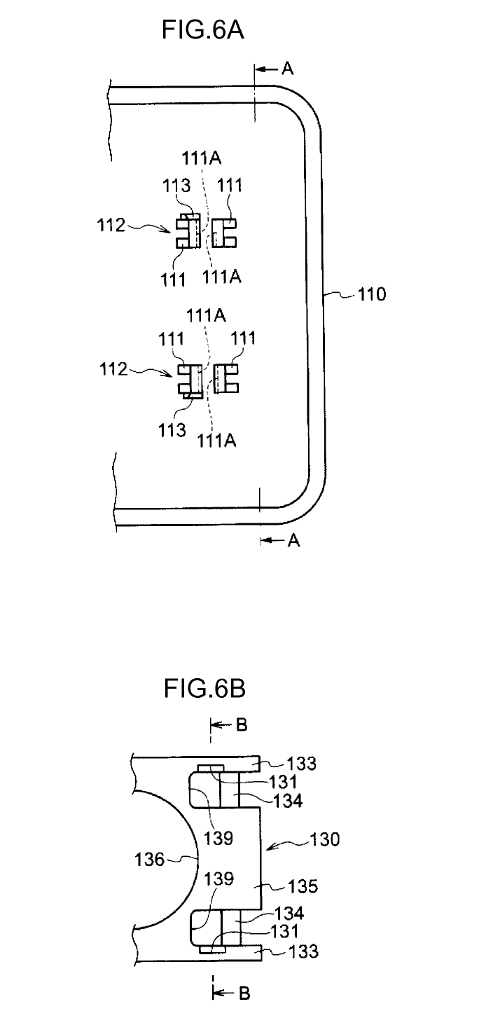

As shown in FIG. 2 to FIG. 8, turning pins 134 are formed between the outer rung portions 133 and the inner rung portion 135, that is, between mutually opposing pairs of side wall faces of each of the cavity portions 139. As is described below, the second link member 130 is turnably retained at the reverse surface of the key top 110 by the turning pins 134. Recesses 131, which are an example of the engaging portion of the present invention, are formed in inner side faces of the outer rung portions 133, that is, in outer side wall faces of the cavity portions 139, in regions between the turning pins 134 and floor faces of the cavity portions 139. Each recess 131 is open to the lower side, that is, toward the membrane sheet 160 (and the back plate 170) but closed to the upper side.

The edge at the other end side of the second link member 130 is cavitated at one location in a direction toward the access hole 136, that is, a direction toward the one end side. A sliding pin 132 is formed between a mutually opposing pair of side wall faces of this cavity portion. The sliding pin 132 is inserted into the second holders 152 of the back plate 170 and retained to be slidable in the horizontal direction.

As shown in FIG. 2 to FIG. 5, axle holes 138, into which the turning axles 126 of the first link member 120 fit, are formed at a central portion of the second link member 130. Thus, the first link member 120 and second link member 130 are supported to be turnable relative to one another by the turning axles 126 of the first link member 120 being fitted into the axle holes 138 of the second link member 130.

As shown in FIG. 1 to FIG. 5, a pair of rotation support portions 112 and a pair of sliding support portions 114 are provided at the surface at the reverse side of the key top 110. The pair of rotation support portions 112 turnably support the turning pins 134 of the second link member 130. The pair of sliding support portions 114 support the sliding pins 122 of the first link member 120 to be turnable and to be translatable (slidable) in the horizontal direction (a direction along the surface at the reverse side of the key top 110).

As shown in FIG. 1 to FIG. 8, the rotation support portions 112 are each provided with a pair of rotation support claws 111. A rotation support surface 111A is formed at a face of each rotation support claw 111 that bears the turning pin 134. The rotation support surface 111A is a concave surface in a tubular surface shape with a radius of curvature that matches an outer periphery face of the turning pin 134. A groove is formed in a face at the opposite side of the rotation support claw 111 from the side thereof at which the rotation support surface 111A is formed in the face that bears the turning pin 134. Thus, each rotation support claw 111 includes a surface with a U-shaped cross-section, in other words, a C-shaped cross-section, that is cavitated toward the rotation support surface 111A as viewed from below.

As shown in FIG. 1 to FIG. 8, at each pair of rotation support claws 111, a protrusion 113, which engage with the recesses 131 of the second link member 130, is provided at a lower end portion of an outer side sidewall of the rotation support claw 111 that is closer to the sliding support portions 114, that is, the rotation support claw 111 at the side closer to the middle of the key. The protrusions 113 are an example of the engaged portion of the present invention. Each protrusion 113 has a cross-section with a wedge shape that widens toward the upper side.

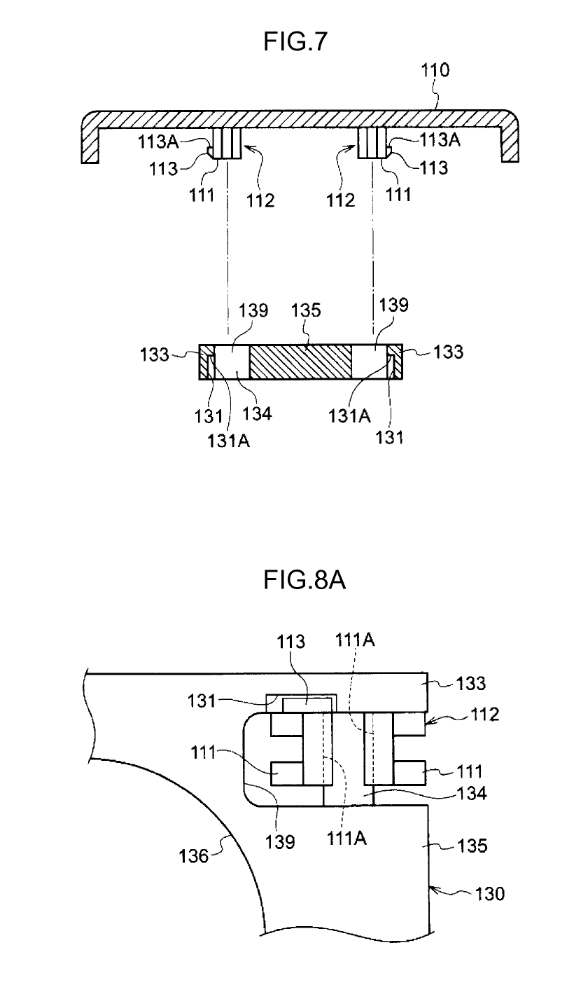

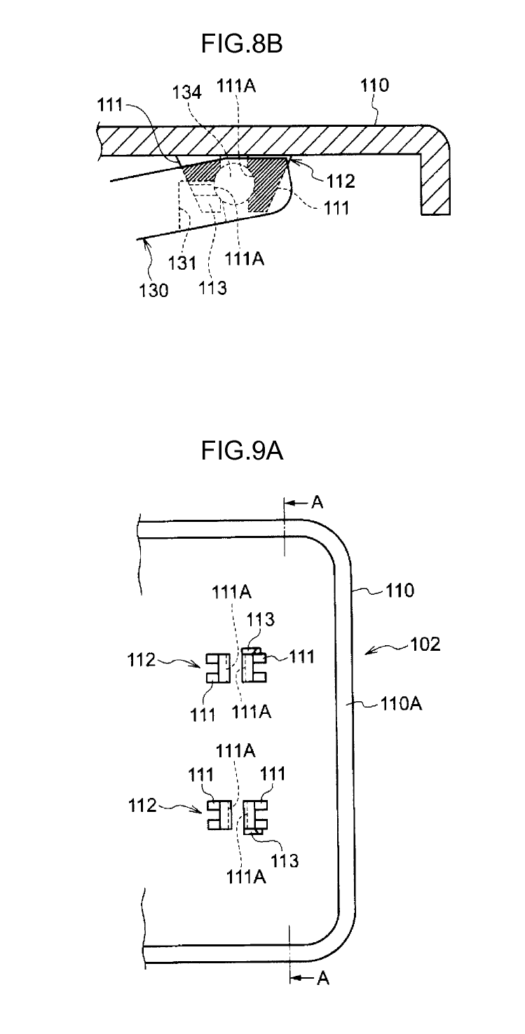

Thus, when the turning pins 134 of the second link member 130 are inserted between the pairs of rotation support claws 111 and put into a state in which the turning pins 134 are borne at the rotation support surfaces 111A, as shown in FIG. 5, FIG. 7, FIG. 8A and FIG. 8B, the protrusions 113 of the rotation support claws 111 enter into the recesses 131 of the second link member 130.

As shown in FIG. 5 and FIG. 8A, in the state in which the second link member 130 is assembled to the key top 110, a gap is formed between the inner side side face of each rotation support claw 111 and the inner rung portion 135 of the second link member 130, that is, between the inner side side face of the rotation support claw 111 and a side wall face of the second link member 130 at the opposite side of the cavity portion 139 from the side thereof at which the recess 131 is formed.

—Key Switch Structure Assembly Sequence—

The key switch structure 100 according to the first embodiment may be assembled in accordance with the following sequence. First, the second link member 130 is fitted in at the inner side of the first link member 120, and the turning axles 126 of the first link member 120 are fitted into the axle holes 138 of the second link member 130, structuring the link mechanism 128.

Then, the turning pins 124 of the first link member 120 of the link mechanism 128 are fitted into the first holders 150 of the back plate 170, and the sliding pin 132 of the second link member 130 is fitted into the second holders 152 of the back plate 170.

Finally, the turning pins 134 of the second link member 130 are fitted into the rotation support portions 112 of the key top 110, and the sliding pins 122 of the first link member 120 are fitted into the sliding support portions 114.

When each turning pin 134 is fitted into the rotation support portion 112 of the key top 110, the turning pin 134 is inserted between the pair of rotation support claws 111 structuring the rotation support portion 112, and is borne by the rotation support surfaces 111A.

As described above, the protrusion 113 is provided protruding from the lower end portion of the outer side face of one of the pair of rotation support claws 111. Thus, when the turning pin 134 is inserted between the rotation support claws 111, the protrusion 113 interferes with the inner side face of the outer rung portion 133 of the second link member 130, which is to say the outer side face of the cavity portion 139.

However, as shown in FIG. 5 and FIG. 8A, a gap is formed between the inner side face of the rotation support claw 111 and the inner rung portion 135 of the second link member 130. Therefore, each rotation support claw 111 at the key middle side and rotation support claw 111 at a key periphery edge side deforming in directions to widen the spacing therebetween. Further, the key middle side rotation support claws resiliently deform in directions to approach one another, that is, resiliently deform toward the inner rung portion 135 of the second link member 130. Accordingly, each protrusion 113 rides over the inner side face of the outer rung portion 133.

When the protrusion 113 of the rotation support claw 111 has ridden over the outer rung portion 133, the rotation support claw 111 returns to the position thereof prior to the resilient deformation. Thus, at the same time as the turning pins 134 are fitted into the rotation support surfaces 111A, the protrusions 113 engage with the recesses 131 formed in the outer rung portions 133.

—Operation—

As shown in FIG. 3, in the key switch structure 100 according to the first embodiment, the first link member 120 and the second link member 130 cross in an X shape to structure the link mechanism 128. Therefore, as mentioned above, the link mechanism 128 is retained at the back plate 170 by the turning pins 124 of the first link member 120 and the sliding pin 132 of the second link member 130, and the link mechanism 128 is retained at the key top 110 by the sliding pins 122 of the first link member 120 and the turning pins 134 of the second link member 130.

In a usual state (a state in which the key top 110 is not depressed), the rubber dome 140 urges the key top 110 in the direction away from the membrane sheet 160 (and the back plate 170). This urging force acts in a direction that increases the angle of crossing between the first link member 120 and the second link member 130.

When the key top 110 is depressed, the turning pins 124 of the first link member 120 turn within the first holders 150 of the back plate 170, and the turning pins 134 of the second link member 130 turn inside the rotation support portions 112 of the key top 110. Meanwhile, the sliding pins 122 of the first link member 120 slide horizontally inside the sliding support portions 114, to a direction away from the turning pins 134 of the second link member 130. At the same time, the sliding pin 132 of the second link member 130 slides within the second holders 152 of the back plate 170, to a direction away from the turning pins 124 of the first link member 120.

Therefore, the first link member 120 and the second link member 130 turn in directions that reduce the overall crossing angle. As a result, the key top 110 moves toward the membrane sheet 160 (and the back plate 170) and presses and deforms the rubber dome 140, while being kept in a horizontal state. The contact point-pressing portion 144 presses the contact portion 166 of the membrane sheet 160, and the switch goes into the closed state.

When a finger is removed from the key top 110, the key top 110 is returned in the direction away from the membrane sheet 160 (and the back plate 170) by operations of the rubber dome 140 and the link mechanism 128, to the height prior to the press, while being kept in the horizontal state by the link mechanism 128. The contact point-pressing portion 144 separates from the contact portion 166 of the membrane sheet 160, and the switch goes into the open state (see FIG. 1).

In the state in which the turning pins 134 of the second link member 130 are plugged into the rotation support portions 112 of the key top 110, each protrusion 113 of the rotation support claws 111 is fitted into the recess 131 formed in the outer rung portion 133. As shown in FIG. 7, this is a state in which an upper face 113A of the protrusion 113 opposes a roof face 131A of the recess 131. Therefore, if the key top 110 is lifted up to some extent relative to the link mechanism 128, the protrusions 113 hook on the roof faces 131A of the recesses 131, and the key top 110 does not lift up any further. Consequently, even when a keyboard is made thinner, it is hard for the key top 110 to detach from the link mechanism 128, specifically from the second link member 130. Therefore, the key top 110 is not detached by something of the order of a fingernail or the like catching under the key top 110 when a key is being pressed.

Moreover, as shown in FIG. 8A, there is hardly any space between the outer side face of each rotation support claw 111 and the inner side face of the outer rung portion 133. Therefore, in both cases when the key top 110 is rising and going downward, the second link member 130 turns relative to the rotation support claws 111 of the key top 110 in a state in which contact is maintained between the outer side faces of the rotation support claws 111 and the inner side faces of the outer rung portions 133, as shown by the region marked with shading lines in FIG. 8B. Thus, twisting of the key top 110 relative to the link mechanism 128 is suppressed.

Furthermore, each rotation support claw 111 is reduced in thickness by being formed in a U-shaped cross section. Thus, even when the thickness of the roof of the key top 110 is reduced, molding problems such as sink marks and the like at the portions at which the engaging dogs are formed may be suppressed.

### 2. Second Embodiment

Herebelow, a key switch structure 102, which is a second example of the key switch structure of the present invention, is described with reference to the drawings.

—Structure—

In the key switch structure 102, the structures of the back plate 170, the first holders 150, the second holders 152, the membrane sheet 160, the rubber dome 140 and the first link member 120 are the same as in the key switch structure 100 according to the first embodiment. Furthermore, the structures of the sliding support portions 114 of the key top 110 are the same as in the key switch structure 100 according to the first embodiment.

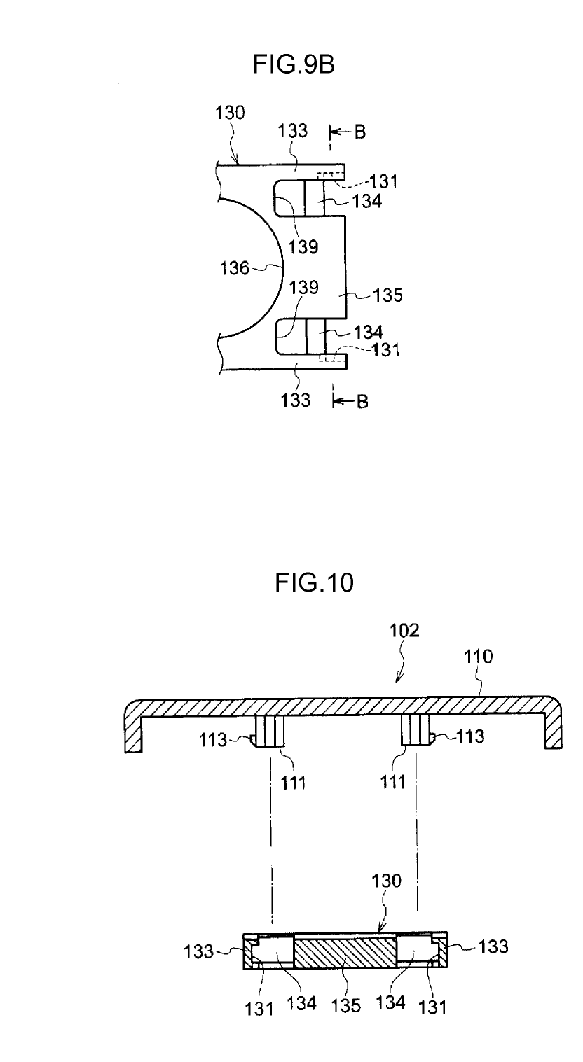

However, as shown in FIG. 9A, FIG. 9B and FIG. 10, the recesses 131 of the second link member 130 are formed in the inner side faces of the outer rung portions 133, in regions at the opposite side of the turning pins 134 from the side thereof at which the floor faces of the cavity portions 139 are disposed. In other words, each recess 131 is formed in the outer side sidewall face of the cavity portion 139, in a region that is toward an end portion side relative to the turning pin 134. Meanwhile, the protrusions 113 that are to enter the recesses 131 are provided at the rotation support claws 111 at the side of the key top 110 that is closer to an outer wall 110A. That is, the protrusions 113 are provided at outer side sidewalls of the rotation support claws 111 that are at the key periphery edge side. Each protrusion 113 is formed in a wedge shape that widens toward the upper side, the same as in the key switch structure 100 according to the first embodiment.

Apart from the points described above, the second link member 130 of the key switch structure 102 has the same structure as the second link member 130 of the key switch structure 100 according to the first embodiment.

—Operation—

An assembly sequence of the key switch structure 102 is the same as that of the key switch structure 100 according to the first embodiment. Operation is also the same as in the key switch structure 100 according to the first embodiment, except that when the turning pins 134 of the second link member 130 are being inserted between the rotation support claws 111 of the key top 110, the rotation support claws 111 at the key edge periphery side resiliently deform in directions to approach one another, that is, in directions towards the inner rung portion 135 of the second link member 130, due to mutual interference between the protrusions 113 and the outer rung portions 133.

In the key switch structure 102 according to the second embodiment, the protrusions 113 are provided at the key periphery edge side rotation support claws 111 of the rotation support portions 112, and the recesses 131 are provided at the inner side faces of the outer rung portions 133 of the second link member 130. Therefore, the key switch structure 102 has an advantage in that, compared to the key switch structure 100 according to the first embodiment in which the protrusions 113 are provided at the key middle side rotation support claws 111, there is less looseness in the up-and-down direction when the key top 110 is lifted up by a fingernail.

### 3. Third Embodiment

Herebelow, a key switch structure 104, which is a third example of the key switch structure of the present invention, is described with reference to the drawings.

—Structure—

In the key switch structure 104, the structures of the back plate 170, the first holders 150, the second holders 152, the membrane sheet 160, the rubber dome 140 and the first link member 120 are the same as in the key switch structure 100 according to the first embodiment. Furthermore, the structures of the sliding support portions 114 of the key top 110 are the same as in the key switch structure 100 according to the first embodiment.

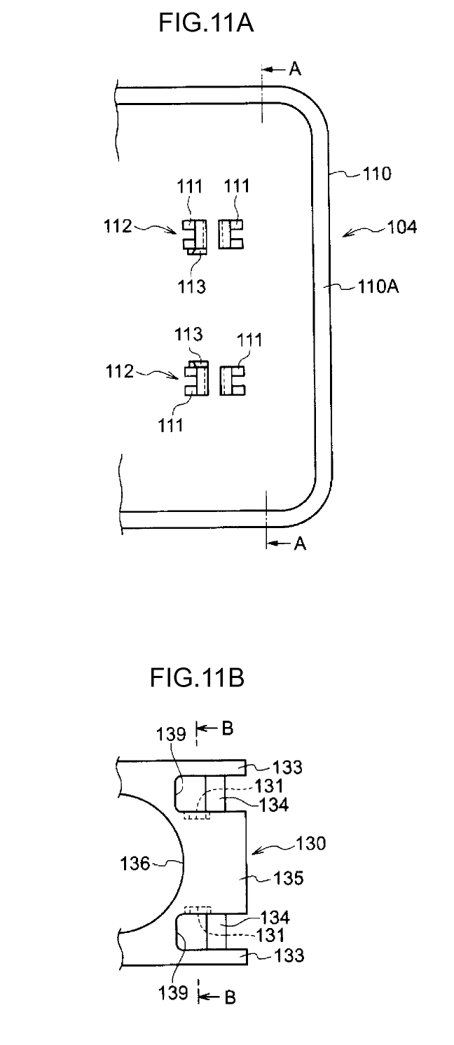

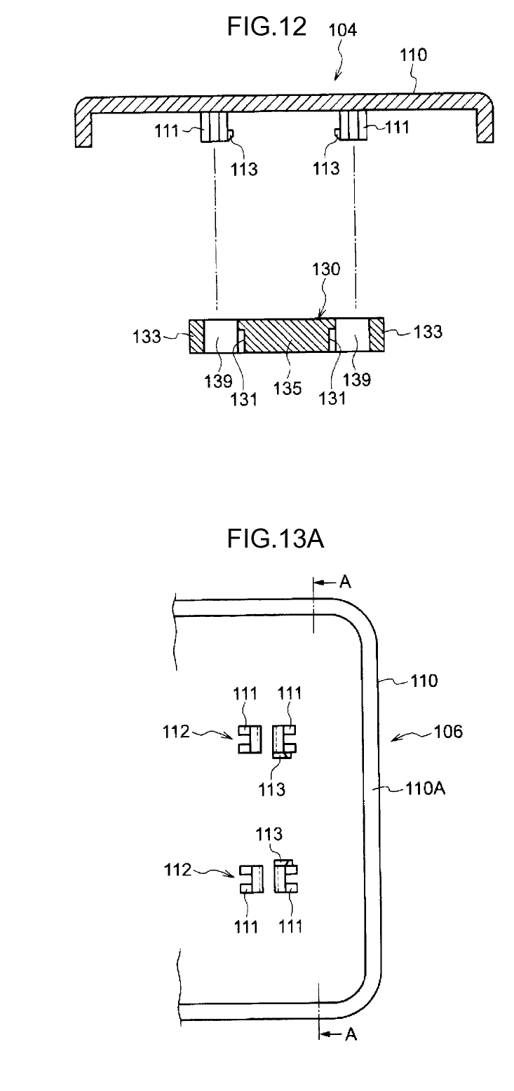

However, as shown in FIG. 11A, FIG. 11B and FIG. 12, the recesses 131 of the second link member 130 are formed in the side faces of the inner rung portion 135, in regions between the turning pins 134 and the floor faces of the cavity portions 139. In other words, each recess 131 is formed in the inner side sidewall face of the cavity portion 139, in a region between the turning pin 134 and the floor face of the cavity portion 139. Meanwhile, the protrusions 113 that are to engage with the recesses 131 are provided at inner side faces of the rotation support claws 111 at the key middle side of the key top 110. Each protrusion 113 is formed in a wedge shape that widens toward the upper side, the same as in the key switch structure 100 according to the first embodiment.

In the state in which the second link member 130 is assembled to the key top 110, a gap is formed between the outer side side face of each rotation support claw 111 and the inner side face of the outer rung portion 133 of the second link member 130, that is, between the outer side side face of the rotation support claw 111 and the opposite side of the cavity portion 139 from the side thereof at which the recess 131 is formed, which opposite side is the outer side sidewall face of the cavity portion 139.

Apart from the points described above, the second link member 130 of the key switch structure 104 has the same structure as the second link member 130 of the key switch structure 100 according to the first embodiment.

—Operation—

An assembly sequence of the key switch structure 104 is the same as that of the key switch structure 100 according to the first embodiment. Operation is also the same as in the key switch structure 100 according to the first embodiment, except that when the turning pins 134 of the second link member 130 are being inserted between the rotation support claws 111 of the key top 110, the rotation support claws 111 at the key middle side resiliently deform in directions towards the outer rung portions 133 of the second link member 130 due to mutual interference between the protrusions 113 and the inner rung portion 135.

In the key switch structure 104 according to the third embodiment, the protrusions 113 are provided at the inner side faces of the key middle side rotation support claws 111 of the rotation support portions 112, and the recesses 131 are provided at the side faces of the inner rung portion 135 of the second link member 130. The inner rung portion 135 is more resistant to deformation than the outer rung portions 133. Therefore, in the key switch structure 104 according to the third embodiment, it is harder for the key top 110 to detach from the link mechanism 128 than in the key switch structure 100 according to the first embodiment in which the protrusions 113 are provided at the outer sides of the key middle side rotation support claws 111.

### 4. Fourth Embodiment

Herebelow, a key switch structure 106, which is a fourth example of the key switch structure of the present invention, is described with reference to the drawings.

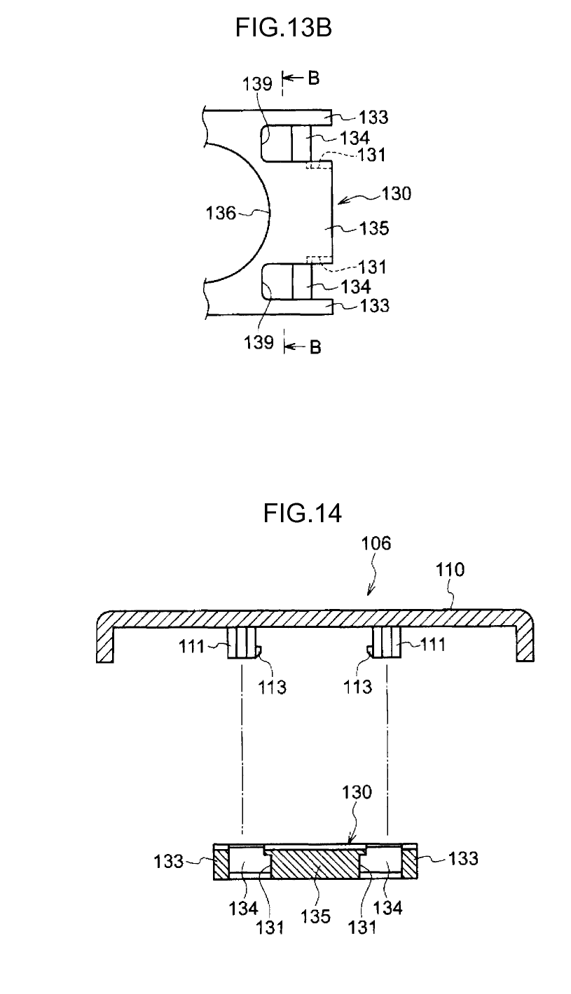

As shown in FIG. 13A, FIG. 13B and FIG. 14, in the key switch structure 106, the recesses 131 are formed in the side faces of the inner rung portion 135 of the second link member 130, in regions at the opposite side of the turning pins 134 from the side thereof at which the floor faces of the cavity portions 139 are disposed. Meanwhile, the protrusions 113 that are to engage with the recesses 131 are provided at inner side faces of the rotation support claws 111 at the key periphery edge side of the key top 110. Apart from the structures described above, the key switch structure 106 has the same structures as the key switch structure 104 according to the third embodiment.

In the key switch structure 106 according to the fourth embodiment, the protrusions 113 are provided at the key periphery edge side rotation support claws 111 of the rotation support portions 112, and the recesses 131 are provided at the side faces of the inner rung portion 135 of the second link member 130, that is, at the inner side sidewall faces of the cavity portions 139. Therefore, the key switch structure 106 has an advantage in that, compared to the key switch structure 104 according to the third embodiment in which the protrusions 113 are provided at the key middle side rotation support claws 111, there is less looseness in the up-and-down direction when the key top 110 is lifted up by a fingernail.

### 5. Fifth Embodiment

Herebelow, a key switch structure 108, which is a fifth example of the key switch structure of the present invention, is described with reference to the drawings.

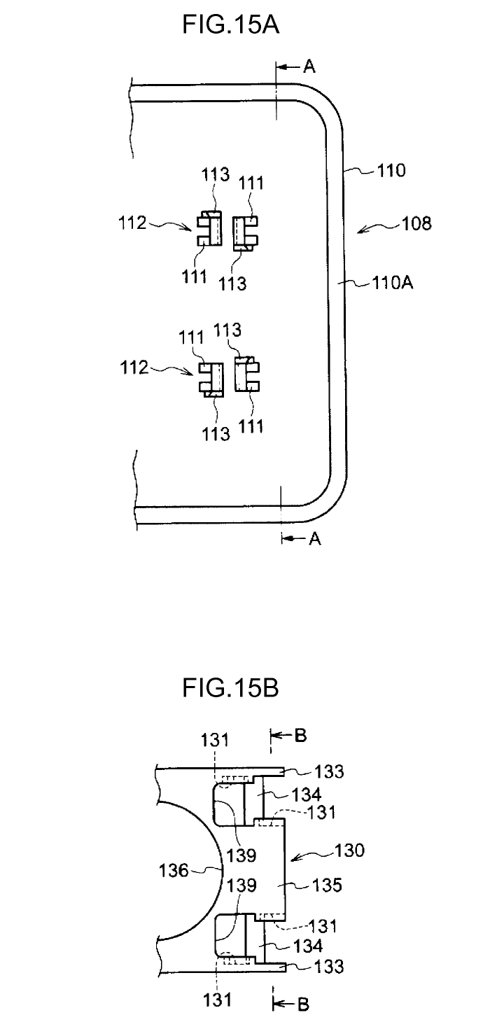

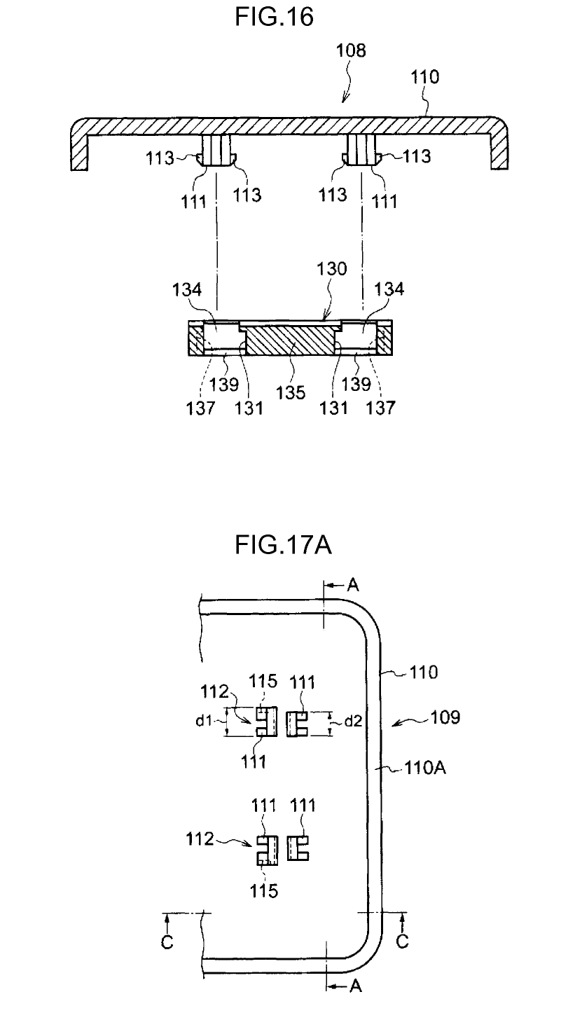

As shown in FIG. 15A, FIG. 15B and FIG. 16, the key switch structure 108 has a structure in which the protrusions 113 are provided protruding from both the outer side side faces of the key middle side rotation support claws 111 and the inner side side faces of the key periphery edge side rotation support claws 111.

Accordingly, at the second link member 130, the recesses 131 are formed both in the inner side faces of the outer rung portions 133, between the turning pins 134 and the floor portions of the cavity portions 139, and in the side faces of the inner rung portion 135, in regions at the opposite side of the turning pins 134 from the side at which the floor faces of the cavity portions 139 are disposed.

As shown in FIG. 15B, the region of the outer side sidewall face of each cavity portion 139 in which the recess 131 is formed protrudes toward the inner side, that is, protrudes toward the inner rung portion 135, relative to the region in which the recess 131 is not formed, with the turning pin 134 serving as a boundary between these regions. Thus, a step is formed in the outer side sidewall face between the region at which the recess 131 is formed and the region at which the recess 131 is not formed.

Meanwhile, the region of the inner side sidewall face of the cavity portion 139 in which the recess 131 is formed protrudes toward the outer side, that is, protrudes toward the outer rung portion 133, relative to the region in which the recess 131 is not formed, with the turning pin 134 serving as a boundary therebetween. Thus, similarly to the outer side sidewall face, a step is formed in the inner side sidewall face between the region at which the recess 131 is formed and the region at which the recess 131 is not formed.

Therefore, the second link member has a shape in which, when viewed from above, each cavity portion 139 is in a crank shape that inflects outward toward the outer rung portion 133. Thus, in the state in which the second link member 130 is assembled to the key top 110, gaps are formed between the faces at the opposite sides of the key middle side rotation support claws 111 and the key periphery edge side rotation support claws 111 from the sides thereof at which the protrusions 113 are provided and the sidewall faces of the cavity portions 139 at the sides at which the recesses 131 are not provided. Thus, when the turning pins 134 are being fitted into the rotation support portions 112, the protrusions 113 of both the key middle side rotation support claws 111 and the key periphery edge side rotation support claws 111 interfere with the second link member 130, and the rotation support claws 111 resiliently deform in directions to pass through these gaps.

Apart from the structures described above, the key switch structure 108 has the same structures as the key switch structure 100 according to the first embodiment.

In the key switch structure 108 according to the fifth embodiment, the protrusions 113 are provided at the rotation support claws 111 at both the key periphery edge side and the key middle side of the rotation support portions 112, and the recesses 131 are provided at both the inner side faces of the outer rung portions 133 of the second link member 130 and the side faces of the inner rung portion 135. Therefore, the key switch structure 108 has an advantage in that, compared to the key switch structures according to embodiments in which the protrusions 113 are provided at either the key middle side rotation support claws 111 or the key periphery edge side rotation support claws 111, it is even harder for the key top 110 to detach from the link mechanism 128.

### 6. Sixth Embodiment

Herebelow, a key switch structure 109, which is a sixth example of the key switch structure of the present invention, is described with reference to the drawings.

—Structure—

In the key switch structure 109, the structures of the back plate 170, the first holders 150, the second holders 152, the membrane sheet 160, the rubber dome 140 and the first link member 120 are the same as in the key switch structure 100 according to the first embodiment. Furthermore, the structures of the sliding support portions 114 of the key top 110 are the same as in the key switch structure 100 according to the first embodiment.

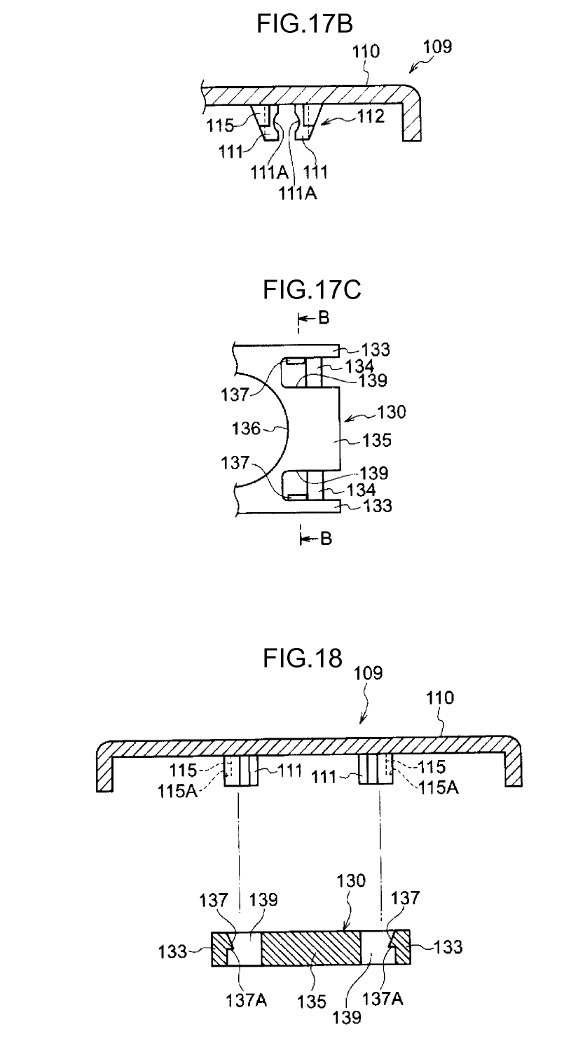

However, as shown in FIG. 17A, FIG. 17B and FIG. 18, in the key switch structure 109, recesses 115 serving as an example of the engaged portion are formed in the outer side side faces of the key middle side rotation support claws 111. Accordingly, a thickness d1 of each key middle side rotation support claw 111 is larger than a thickness d2 of each key periphery edge side rotation support claw 111 by an amount corresponding to the depth of the recess 115. Each recess 115 is formed in a shape that is open in a direction toward the sliding support portions 114, that is, toward the key middle side, but closed in a direction toward the back plate 170, that is, to the lower side.

Correspondingly, at the second link member 130, protrusions 137 that serve as an example of the engaging portion, engaging with the recesses 115 of the rotation support claws 111 are formed at the inner side faces of the outer rung portions 133, that is, at each portion of the outer side sidewall faces of the cavity portion 139 between the turning pin 134 and the floor face of the cavity portion 139. As shown in FIG. 18, each protrusion 137 is formed in a wedge shape that widens toward the lower side.

Apart from the points described above, the second link member 130 of the key switch structure 109 has the same structure as the second link member 130 of the key switch structure 100 according to the first embodiment (see FIG. 17C).

—Operation—

An assembly sequence of the key switch structure 109 is the same as that of the key switch structure 100 according to the first embodiment. However, when the turning pins 134 of the second link member 130 are being inserted between the rotation support claws 111 of the key top 110, the rotation support claws 111 at the key middle side deform in directions to approach one another, which is to say towards the inner rung portion 135, and the outer rung portions 133 resiliently deform to the outer sides, due to mutual interference between the protrusions 137 of the outer rung portions 133 and the key middle side rotation support claws 111.

As described above, each recess 115 is formed in the shape that is closed to the lower side, and each protrusion 137 is in the wedge shape that widens toward the lower side. Therefore, in the state in which the turning pins 134 of the second link member 130 are borne at the rotation support surfaces 111A of the key top 110, each protrusion 137 engages with the recess 115 of the rotation support claw 111. This is a state in which a floor face 137A of the protrusion 137, shown in FIG. 18, opposes a floor face 115A of the recess 115. Therefore, if the key top 110 is lifted up to some extent relative to the link mechanism 128, the protrusions 137 hook on the floor faces 115A of the recesses 115, and the key top 110 does not lift up any further.

Moreover, because the thickness d1 of each key middle side rotation support claw 111 at which the recess 115 is provided is larger than the thickness d2 of each key middle side rotation support claw 111 of the key switch structure 100 according to the first embodiment, the rotation support claws 111 at which the recesses 115 are provided are more resistant to resilient deformation in the directions towards one another. Therefore, a removal force required to disengage the protrusions 137 from the recesses 115 is larger than a removal force required to disengage the protrusions 113 from the recesses 131 in a key switch structure in which the thicknesses of the key middle side rotation support claws 111 and the key periphery edge side rotation support claws 111 are set to d2. Therefore, in the key switch structure according to the sixth embodiment, compared to a key switch structure in which the thicknesses of the key middle side rotation support claws and the key periphery edge side rotation support claws 111 are d2, it is even harder for the key top 110 to detach from the link mechanism 128.

### 7. Seventh Embodiment

Herebelow, a key switch structure 200, which is a seventh example of the key switch structure of the present invention, is described with reference to the drawings.

—Structure—

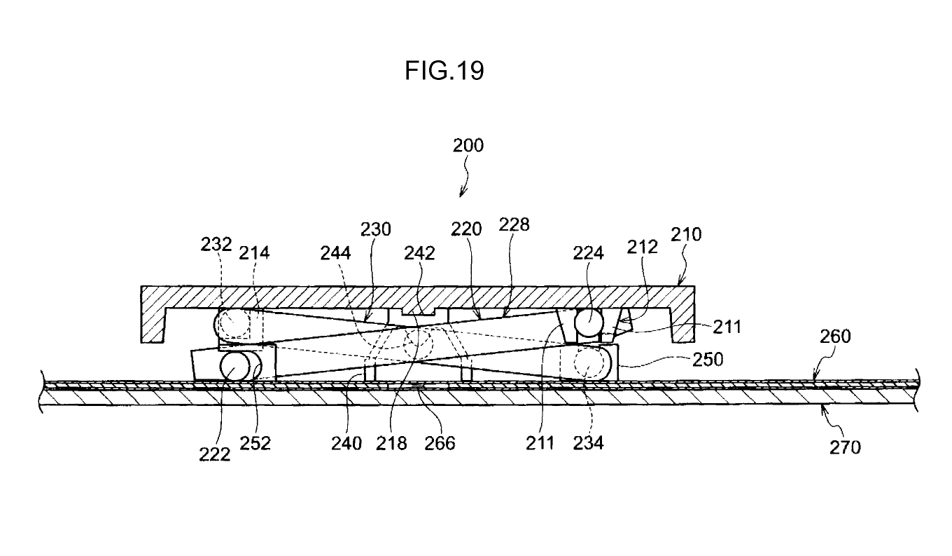

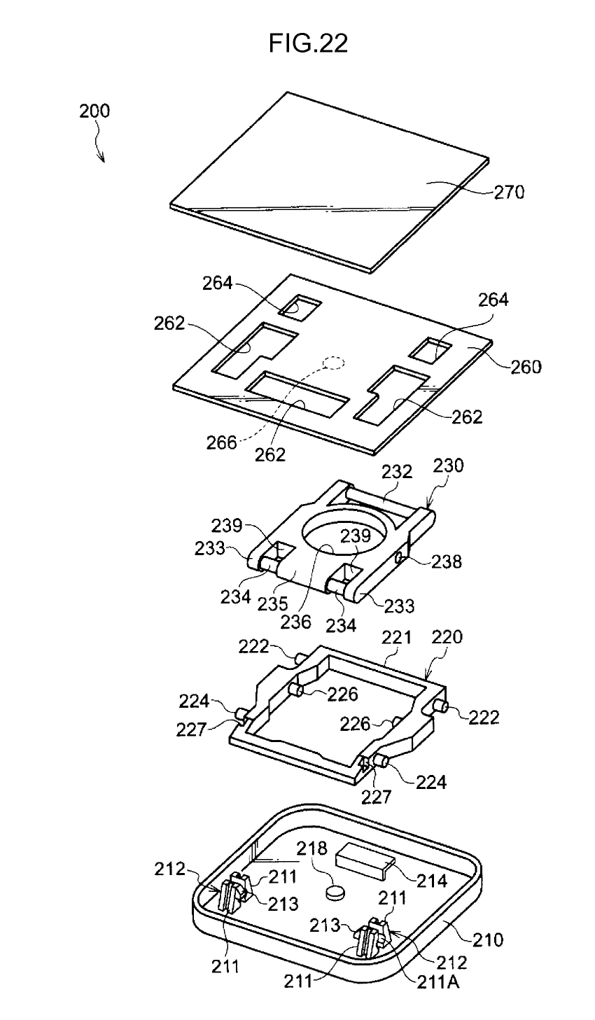

As shown in FIG. 19 to FIG. 22, the key switch structure 200 includes a key top 210, a link mechanism 228 structured with a first link member 220 and a second link member 230, a rubber dome 240 that serves as the resilient member, a membrane sheet 260, and a back plate 270 at which first holders 250 and second holders 252 are mounted. In this case, the first link member 220 and the second link member 230 correspond to the one link member and the other link member of the present invention.

The back plate 270 is a plate formed of a material provided with some degree of hardness and rigidity, such as a metal or a stiff resin or the like. The membrane sheet 260 has a structure in which two sheets on which wiring patterns are printed sandwich a spacer sheet, which is not shown in the drawings, that is, an upper sheet and a lower sheet, which are not shown in the drawings, are adhered to the spacer sheet, and the membrane sheet 260 is formed of a soft material adhered to the surface of the back plate 270.

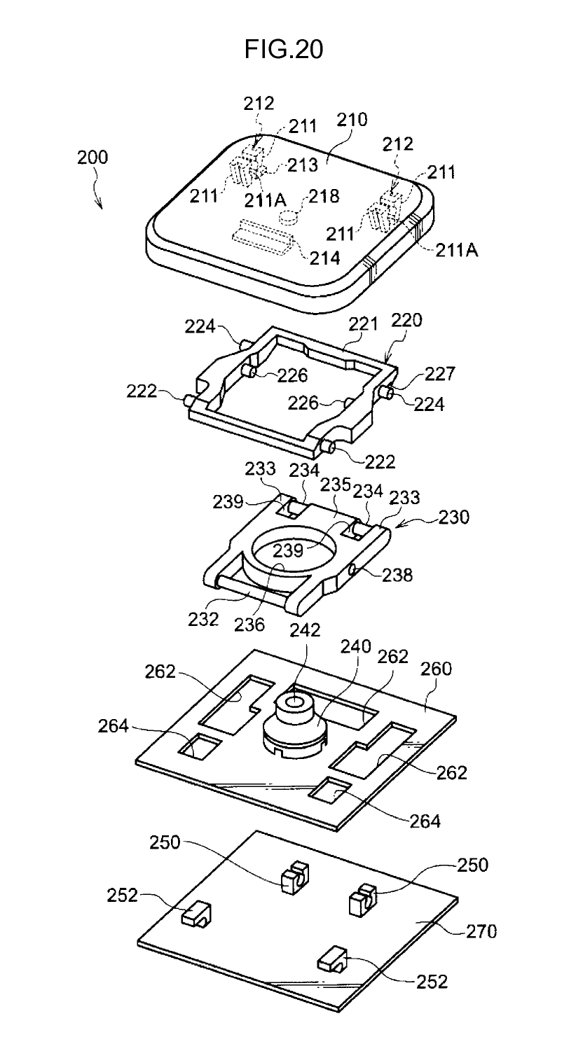

As shown in FIG. 20 to FIG. 22, the membrane sheet 260 is adhered onto the back plate 270 such that the first holders 250 and second holders 252 protrude through holes 262 and 264, respectively. The holes 262 and 264 are formed in the membrane sheet 260 to match the positions of the first holders 250 and the second holders 252.

As shown in FIG. 19, a contact portion 266 is provided at the middle of the membrane sheet 260. The rubber dome 240 is fixed by adhesive or the like between the membrane sheet 260 and the key top 210, over the contact portion 266. The rubber dome 240 is formed in a substantial cup shape of a material such as rubber or the like, and the rubber dome 240 includes a fitting hole 242 at the middle of an upper portion thereof. A contact point-pressing portion 244 is formed, protruding toward the membrane sheet 260, at a central portion of an inner face of the rubber dome 240.

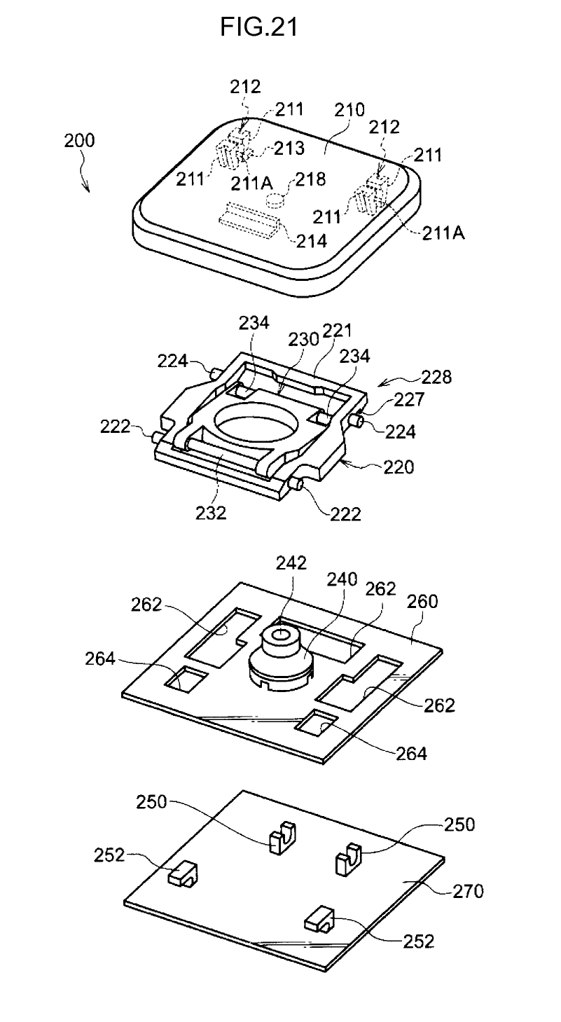

Herebelow, the first link member 220, the second link member 230 and the link mechanism 228 are described. As shown in FIG. 21, the first link member 220 and the second link member 230 form a nested structure in which the second link member 230 is fitted in at the inner side of the first link member 220. Thus, the link mechanism 228 is structured as a pantograph mechanism by the first link member 220 and the second link member 230.

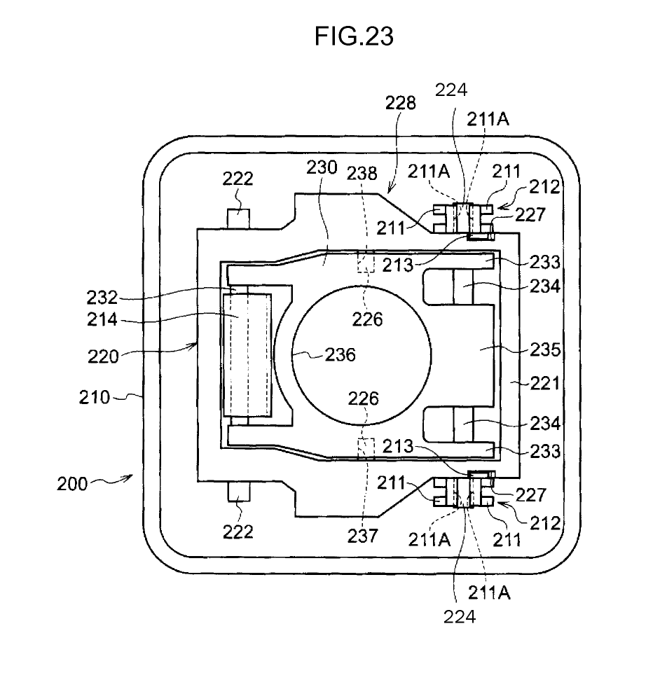

As shown in FIG. 20 to FIG. 23, the first link member 220 is the link member at the outer side of the link mechanism 228, and is provided with a frame body 221 formed in a substantially rectangular frame shape, a pair of turning pins 224 that are formed at one end side of the frame body 221, a pair of sliding pins 222 that are formed at the other end side of the frame body 221 and a pair of turning axles 226 that protrude to the inner side from a central portion of the frame body 221. The pair of turning pins 224 are turnably retained at a reverse surface of the key top 210 (the face at the side that opposes the membrane sheet 260, which is to say the back plate 270). The pair of sliding pins 222 are retained at the second holders 252 of the back plate 270 to be slidable in a horizontal direction, that is, a direction along the surface of the membrane sheet 260.

Recesses 227 are formed in outer side faces of the frame body 221 of the first link member 220, in vicinities of the turning pins 224. The recesses 227 open in the direction toward the back plate 270, that is, to the lower side.

As shown in FIG. 20 to FIG. 23, the second link member 230 is the link member at the inner side of the link mechanism 228. A circular access hole 236, for allowing the rubber dome 240 to pass through, is opened at a central portion of the second link member 230. Thus, the second link member 230 is also formed in a frame shape overall.

An edge at one end side of the second link member 230 is formed with cavity portions 239 at two locations. The cavity portions 239 are cavitated in parallel with one another in a direction toward the access hole 236, that is, a direction toward the other end side of the second link member 230. A portion between the two cavity portions 239 serves as an inner rung portion 235, and respective portions at the outer sides of the cavity portions 239 serve as outer rung portions 233. Thus, the outer rung portions 233 are formed at two locations and the inner rung portion 235 is formed at one location.

Respective turning pins 234 are formed between the outer rung portions 233 and the inner rung portion 235. As is described below, the second link member 230 is turnably retained at the first holders 250 of the back plate 270 by the turning pins 234.

The edge at the other end side of the second link member 230 is cavitated at one location in a direction toward the access hole 236, that is, a direction toward the one end side. A sliding pin 232 is formed between a mutually opposing pair of side wall faces of this cavity portion. The sliding pin 232 is retained to be slidable in the horizontal direction at the reverse surface of the key top 210, as described below.

As shown in FIG. 20 to FIG. 23, axle holes 238 are formed at a central portion of the second link member 230. The turning axles 226 of the first link member 220 fit into the axle holes 238. Thus, the first link member 220 and second link member 230 are supported to be turnable relative to one another by the turning axles 226 of the first link member 220 being fitted into the axle holes 238 of the second link member 230.

As shown in FIG. 19 to FIG. 23, a pair of rotation support portions 212 and a pair of sliding support portions 214 are provided at the surface at the reverse side of the key top 210. The pair of rotation support portions 212 turnably support the turning pins 224 of the second link member 220. The pair of sliding support portions 214 support the sliding pin 232 of the second link member 230 to be turnable and to be translatable (slidable) in the horizontal direction (a direction along the surface at the reverse side of the key top 210).

As shown in FIG. 19 to FIG. 23, the rotation support portions 212 are each provided with a pair of rotation support claws 211. Rotation support surfaces 211A are formed at faces at sides of the rotation support claws 211 that correspond with one another. Each rotation support surface 211A is a concave surface in a tubular surface shape with a radius of curvature that matches an outer periphery face of the turning pin 224. The turning pins 224 are borne at the rotation support surfaces 211A. A groove is formed in a face at the opposite side of each rotation support claw 211 from the side thereof at which the rotation support surface 211A is formed. Thus, the rotation support claw 211 includes a surface with a U-shaped cross-section, in other words, a C-shaped cross-section, that is cavitated toward the rotation support surface 211A as viewed from below.

At each pair of rotation support claws 211, a protrusion 213 that engage with the recesses 227 of the first link member 220 is provided at a lower end portion of an inner side sidewall of the rotation support claw 211 at the key periphery edge side. Each protrusion 213 has a cross-section with a wedge shape that widens toward the upper side.

Thus, when the turning pins 224 of the first link member 220 are inserted between the rotation support claim 211, the protrusions 213 of the rotation support claws 211 fit into the recesses 227 of the first link member 220.

—Key Switch Structure Assembly Sequence—

The key switch structure 200 according to the seventh embodiment may be assembled in accordance with the following sequence, similarly to the key switch structure 100 according to the first embodiment. First, the second link member 230 is fitted in at the inner side of the first link member 220, and the turning axles 226 of the first link member 220 are fitted into the axle holes 238 of the second link member 230, structuring the link mechanism 228.

Then, the turning pin 234 of the second link member 230 of the link mechanism 228 are fitted into the first holders 250 of the back plate 270, and the sliding pins 222 of the first link member 220 are fitted into the second holders 252 of the back plate 270.

Finally, the turning pins 224 of the first link member 220 are fitted into the rotation support portions 212 of the key top 210, and the sliding pin 232 of the second link member 230 is fitted into the sliding support portion 214.

When each turning pin 224 is fitted into the rotation support portion 212 of the key top 210, the turning pin 224 is inserted between the pair of rotation support claws 211 structuring the rotation support portion 212, and is fitted in between the rotation support surfaces 211A. As described above, each protrusion 213 is provided protruding from the lower end portion of the inner side face of, of the pair of rotation support claws 211, the rotation support claw 211 that is at the key periphery edge side. Therefore, when the turning pin 224 is inserted between the rotation support claws 211, the protrusion 213 interferes with an outer side face of the frame body 221 of the first link member 220. Then, in addition to each rotation support claw 211 at the key middle side and rotation support claw 211 at the key periphery edge side resiliently deforming in directions to widen the spacing therebetween, the two key periphery edge side rotation support claws 211 resiliently deform in directions away from one another, that is, resiliently deform in directions away from the first link member 220. Accordingly, each protrusion 213 rides over the outer side face of the frame body 221.

When the protrusion 213 of the rotation support claw 211 has ridden over the outer side face of the frame body 221, the rotation support claw 211 returns to the position thereof prior to the resilient deformation. Hence, the turning pins 224 are borne at the rotation support surfaces 211A and the protrusions 213 are engaged with the recesses 227.

—Operation—

As shown in FIG. 21, in the key switch structure 200 according to the seventh embodiment, the first link member 220 and the second link member 230 cross in an X shape to structure the link mechanism 228. Therefore, the link mechanism 228 is retained at the back plate 170 by the sliding pins 222 of the first link member 220 and the turning pins 234 of the second link member 230, and the link mechanism 228 is retained at the key top 210 by the turning pins 224 of the first link member 220 and the sliding pin 232 of the second link member 230.

In a usual state, (a state in which the key top 210 is not depressed), the rubber dome 240 urges the key top 210 in the direction away from the membrane sheet 260. This urging force acts in a direction that increases the angle of crossing between the first link member 220 and the second link member 230.

When the key top 210 is depressed, the sliding pins 222 of the first link member 220 turn within the second holders 252 of the back plate 270 and slide in the direction away from the turning pins 234 of the second link member 230. Meanwhile, the sliding pin 232 of the second link member 230 slides inside the sliding support portions 214 of the key top 210 in the direction away from the turning pins 224 of the first link member 220. At the same time, the turning pins 224 of the first link member 220 turn inside the rotation support portions 212 of the key top 210, and the turning pins 234 of the second link member 230 turn within the first holders 250 of the back plate 270.

Therefore, the first link member 220 and the second link member 230 turn in directions that reduce the overall crossing angle. As a result, the key top 210 moves toward the membrane sheet 260 (and the back plate 270) and presses and deforms the rubber dome 240, while being kept in the horizontal state. The contact point-pressing portion 244 presses the contact portion 266 of the membrane sheet 260, and the switch goes into the closed state.

When a finger is removed from the key top 210, the key top 210 is returned in the direction away from the membrane sheet 260 (and the back plate 270) by operation of the rubber dome 240 and the link mechanism 228, to the height prior to the press, while being kept horizontal by the link mechanism 228. The contact point-pressing portion 244 separates from the contact portion 266 of the membrane sheet 260, and the switch goes into the open state (see FIG. 19).

In the state in which the turning pins 224 of the first link member 220 are plugged into the rotation support portions 212 of the key top 210, each protrusion 213 of the rotation support claws 211 engages with the recess 227 of the first link member 220. This is a state in which an upper face of the protrusion 213 opposes a roof face of the recess 227. Therefore, if the key top 210 is lifted up to some extent relative to the link mechanism 228, the protrusions 213 hook on the roof faces of the recesses 237, and the key top 210 does not lift up any further. Consequently, even when a keyboard is made thinner, it is hard for the key top 210 to detach from the link mechanism 228. Therefore, the key top 210 is not detached by something of the order of a fingernail or the like catching under the key top 210 when a key is being pressed.

As shown in FIG. 20 to FIG. 23, each rotation support claw 211 is reduced in thickness by being given a U-shaped cross section. Thus, even when the plate thickness of the roof of the key top 210 is reduced, molding problems such as sink marks and the like at the portions at which the engaging dogs are formed may be suppressed.

1. A key switch structure comprising:
a link mechanism that includes
one link member, one end side of which turnably engages with a rotation support portion provided at a reverse surface of a key top that is depressed to allow a contact point to conduct electricity, and an other end side of which is slidably retained at a surface of a back plate, and
an other link member that is turnably coupled with the one linked member, one end side of the other linked member being turnably retained at the surface of the back plate and an other end side of the other link member being slidably retained at the reverse surface of the key top,
the link mechanism supporting the key top to be movable toward and away from the back plate;
an engaging portion provided at the one link member; and
an engaged portion formed at the rotation support portion, the engaged portion engaging with the engaging portion and restricting detachment of the key top from the one link member.

2. The key switch structure according to claim 1, wherein the engaging portion is a recess formed at the one link member, the recess opening to a side thereof at which the back plate is disposed, and
the engaged portion is a protrusion formed at the rotation support portion, the protrusion entering the recess through the opening thereof.

3. The key switch structure according to claim 1, wherein the engaging portion is a protrusion formed at the one link member, and
the engaged portion is a recess formed at the rotation support portion, the recess being closed to a side thereof at which the back plate is disposed, and the protrusion entering the recess.

4. The key switch structure according to claim 2, wherein
a turning pin is formed at the one end side of the one link member,
the rotation support portion includes a pair of rotation support claws, rotation support surfaces being formed at faces at sides of the rotation support claws that oppose one another, the rotation support surfaces being concave surfaces that bear the turning pin,
the recess is formed at the one link member in a vicinity of the turning pin, and
the protrusion is formed at the rotation support claws.

5. The key switch structure according to claim 3, wherein
a turning pin is formed at the one end side of the one link member,
the rotation support portion includes a pair of rotation support claws, rotation support surfaces being formed at faces at sides of the rotation support claws that oppose one another, the rotation support surfaces being concave surfaces that bear the turning pin,
the protrusion is formed at the one link member in a vicinity of the turning pin, and
the recess is formed at the rotation support claws.

6. The key switch structure according to claim 4, wherein a groove is formed in a face of each rotation support claw at the opposite side thereof from the side at which the concave surface is formed.

7. The key switch structure according to claim 5, wherein a groove is formed in a face of each rotation support claw at the opposite side thereof from the side at which the concave surface is formed.
